(19) United States
(12) Patent Application Publication
(10) Pub. No.: US 2005/0215405 A1
(43) Pub. Date: Sep. 29, 2005

(54) Crease and embossing die

(75) Inventor: Kevin L. Corcoran, Mission Viejo, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Ellison Educational Equipment, Inc., Lake Forest, CA (US)

(21) Appl. No.: 11/083,120

(22) Filed: Mar. 16, 2005

Related U.S. Application Data
(60) Provisional application No. 60/554,003, filed on Mar. 16, 2004.

(51) Int. Cl. B26B 1/00

(52) U.S. Cl. 493/143

(57) ABSTRACT

Disclosed herein is an embossing and crease die that includes a base portion having a top surface with a recessed area, the recessed area has a plurality of channels defining a shape. The crease die further includes an insert portion having a body with a bottom surface that is adapted to be inserted into the recessed area of the base portion. The insert further includes a plurality of protrusions that are adapted to be inserted into the plurality of channels. The top surface of the base portion is adapted to provide resistance to the bottom surface of the insert portion when the insert portion is inserted in the recessed area of the base so as to prevent the plurality of protrusions from contacting the plurality of channels so that the insert portion and the base portion do not crush a working medium, such as paper or the like.

### CROSS-REFERENCES TO RELATED APPLICATIONS

This application claims priority to U.S. Provisional Application No. 60/554,003 (Attorney Docket No. 021919-004600US) filed Mar. 16, 2004 and is herein incorporated by reference for all purposes.

### FIELD OF DISCLOSURE

The present disclosure relates to dies used to emboss media and, more particularly, dies that are used to emboss or provide a crease in a flat medium used in the arts and crafts industry, such as paper or the like.

### BACKGROUND OF THE DISCLOSURE

In the arts and crafts industry, dies that are used with die presses may include a steel rule configured to a desired shape, wherein the steel rule extends from a wooden base and the die is placed between the platens of a die press, and when force is exerted to the platens and to the die, the steel rule cuts through a medium, such as sheet stock. The sheet stock may be paper, vinyl, leather, or the like. The desired shape is cut from the cutting medium by the steel rule die piercing through the medium. Steel ruled dies may further include interior steel rule sections or portions that are located within the exterior configuration of the steel rule die. The interior steel rule pieces may include portions or sections that are not sharpened to a point and, therefore, are not intended to pierce the medium, but instead are intended to emboss a shape into the working medium or to provide a crease in the medium so that when the resulting cut shape of the medium is removed from the die press, the medium includes crease lines for the user to fold the medium to a desired shape.

The drawback, however, of including these embossing or crease steel rule sections within the steel rule cutting die is that it is difficult to provide a female receiving section opposite of the steel rule cutting die or the steel rule embossing die, wherein a female section accepts the male portion, i.e., the steel rule creased die portion. Therefore, it is difficult to register a female receiving portion on the lower platen of the die press to accept the crease steel rule die portion of the die because it requires a manual alignment between the male crease rule die portion and the female receiving portion before a medium can be inserted between the male and female portions. In addition, it is very difficult, if not impossible to control the depth of insertion of the crease rule die portion into the female receiving portion and, therefore, the medium is typically crushed to the point of failure. This creates additional problems if the working media is a colored material. For example, if colored construction paper is used as the medium, when the exterior surfaces of the colored construction paper are creased to the point of failure, then internal fibers of the construction paper are exposed and typically, the internal fibers are not the same color as the colored exterior surface of the working media. For example, most interior fibers of colored construction paper are white or cream in color and, therefore, the resulting shape from the steel ruled die includes, in this example, cuts or failure in the working material where not intended, and an exposes the interior fibers that are a different color than the chosen working material. This result is not desired, particularly in the arts and crafts industry.

### BRIEF SUMMARY OF THE DISCLOSURE

Disclosed herein is an embossing and crease rule die that includes a base having a top surface with a recessed area, the recessed area has a plurality of channels defining a shape. The crease rule die further includes an insert having a body with a bottom surface that is adapted to be inserted into the recessed area of the base. The insert further includes a plurality of protrusions that are adapted to be inserted into the plurality of channels. The top surface of the base is adapted to provide resistance to the bottom surface of the insert when the insert is inserted in the recessed area of the base so as to prevent the plurality of protrusions from contacting the plurality of channels so that the insert and the base do not crush a working medium, such as paper or the like.

In another aspect of the disclosure, disclosed is a crease rule die that includes a base having a top surface with a recessed area, the recessed area has a plurality of channels to defining a shape. The crease rule die further includes an insert having a body with a bottom surface that is adapted to be inserted into the recessed area of the base. The insert further includes a plurality of protrusions that are adapted to be inserted into the plurality of channels. The top surface of the base is adapted to provide resistance to the bottom surface of the insert when the insert is inserted in the recessed area of the base so as to prevent the plurality of protrusions from contacting the plurality of channels so that the insert and the base do not crush a working medium, such as paper or the like. The insert and the base may include a means of registration, such as the base having a keyway and the insert having a key so that the insert is inserted with the proper orientation relative to the base.

In yet another aspect of the disclosure, a crease rule die is disclosed that is similar to the crease rule die described above, except that the inserts further includes a top surface with a grip that extends outwardly from the top surface to provide a means for the user to insert and remove the insert relative to the base. A grip may be generally parallel with the insert top surface so that the grip acts as a pressure stabilizer when pressure is applied to the crease rule die from a die press. The base may further include a means of extraction, such as an opening through the recessed area to allow the user to remove the working medium after the working medium has been embossed or creased.

In another aspect of the disclosure, the crease rule die is made of a plastic material that has a durometer range of 85 a to 75 d.

### BRIEF DESCRIPTION OF THE DRAWINGS

This disclosure will now be described in greater detail with reference to the preferred embodiments illustrated in the accompanying drawings, in which like elements bear like reference numerals, and wherein:

FIG. 1 is a front exploded perspective view of the crease rule die according to the present disclosure;

FIG. 2 is a front perspective view of the crease rule die according to the present disclosure;

FIG. 3 is a top plan view of the crease rule die;

FIG. 4 is a side elevational view taken from line 4-4 taken from FIG. 3.

FIG. 5 is a top planned view of the base;

FIG. 6 is a bottom planned view of the base;

FIG. 7 is a cross-sectional view taken from line 7-7 from FIG. 5;

FIG. 8 is a close-up view taken view taken from FIG. 7.

FIG. 9 is a close-up view taken from FIG. 7.

FIG. 10 is a bottom elevational view of the insert portion;

FIG. 11 is a top planned view of the insert portion;

FIG. 12 is a cross-sectional view taken from line 12-12 from FIG. 11;

FIG. 13 is a close-up view taken from FIG. 12;

FIG. 14 is a cross-sectional view taken from line 14-14 of FIG. 3;

FIG. 15 is a close-up view taken from FIG. 14, showing a working medium sandwiched between the base portion and the insert portion;

FIG. 16 is a close-up cross-sectional view similar to FIG. 15 with the working medium shown removed; and

FIG. 17 is a top plan view of a second embodiment utilizing a key and keyway;

FIG. 18 is an exploded front view of the second embodiment;

FIG. 19 is a cross-sectional view taken from line B-B from FIG. 17;

FIG. 20 is an exploded right hand side view of the second embodiment;

FIG. 21 is a top plan view of the base portion of the second embodiment;

FIG. 22 is a cross-sectional view of the base portion of the second embodiment taken along line F-F of FIG. 21;

FIG. 23 is a cross-sectional view of the base portion of the second embodiment taken along C-C, and detailed views D and E are taken from cross-sectional view C-C of FIG. 23;

FIG. 24 is a top plan view of the insert portion of the second embodiment;

FIG. 25 is a side elevational view of the insert portion of the second embodiment;

FIG. 26 is a cross-sectional view taken from line G-G of FIG. 24, and detailed views H, I, and J are taken from FIG. 26;

FIG. 27 is a perspective exploded-partial see-through view of a third embodiment utilizing a three-dimensional base portion and insert portion;

FIG. 28 is a top plan, partial see-through view of the third embodiment;

FIG. 29 is a cross-sectional view taken from line B-B of FIG. 28;

FIG. 30 is a cross-sectional view taken from line A-A of FIG. 28;

FIG. 31 is a perspective view of the base portion of the third embodiment;

FIG. 32 is a top plan view of the base portion of the third embodiment;

FIG. 33 is a cross-sectional view taken from line D-D of FIG. 32;

FIG. 34 is a cross-sectional view taken from line C-C of FIG. 32;

FIG. 35 is a perspective view of the insert portion of the third embodiment;

FIG. 36 is a top plan view of the insert portion of the third embodiment;

FIG. 37 is a cross-sectional view taken from line G-G of FIG. 36;

FIG. 38 is a cross-sectional view taken from line F-F of FIG. 36;

FIG. 39 is a perspective view of the third embodiment with the insert portion being lifted out of the base portion;

FIG. 40 is a perspective view of the third embodiment; and

FIG. 41 is a perspective view of the insert portion of the third embodiment.

### DETAILED DESCRIPTION OF THE INVENTION

Disclosed as a die that may be used for embossing an impression upon or into a working medium, such as paper, vinyl, leather, plastic, or the like. The crease rule die also may be used to deform the working medium to include a crease or a pattern of creases as defined by the die. After the working medium has been removed from the die, the working medium may be folded along the crease line or crease lines so that the working medium may be folded into a resulting shape, such as a geometric configuration or the like.

The die disclosed herein includes a base portion and an insert portion that work together to sandwich the working medium between the base and the insert. The die is then placed in a die press, such as the die press disclosed in U.S. Pat. No. 6,619,195 assigned to the same assignee as the present disclosure. The die disclosed herein is positioned between the lower platen and the upper platen of a die press, or any other means for exerting pressure to the die, so as to force the insert portion of the die into the base portion of the die. The forcing of the insert portion into the base portion creases an embossing, creasing, or both embossing and creasing of the working medium of the insert portion and the base portion sandwiching the working medium.

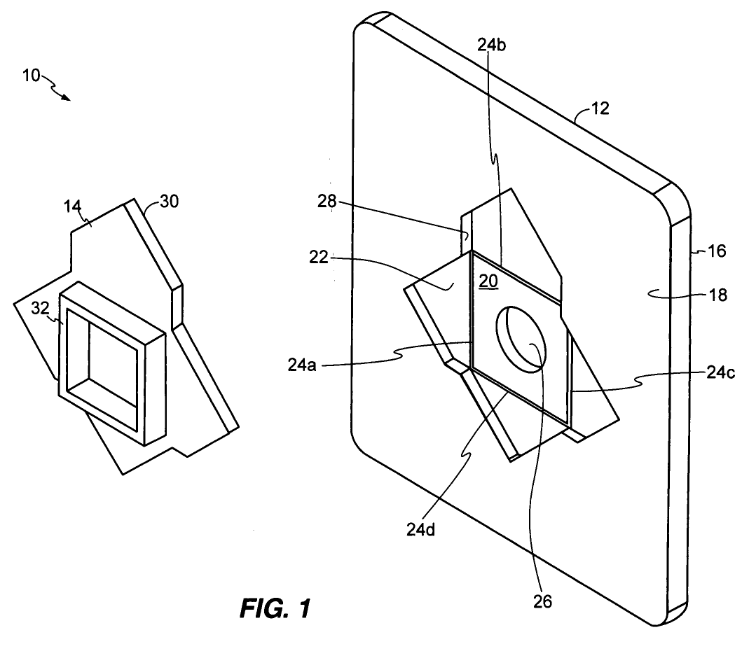

FIG. 1 illustrates the crease rule die 10 of the present disclosure. The crease rule die as used herein includes the functions of creasing a working medium or embossing a shape on a working medium, or a combination of creasing and embossing onto a working medium. Therefore, the term crease die as used herein is not intended to limit the claims of the present disclosure to a die that forms creases onto a working medium. The die 10 includes a base portion 12 and a corresponding insert portion 14. The base portion 12 includes a base rear surface 16 and an opposite base top surface 18. The base top surface 18 includes a base recessed area 20 that corresponds to the shape or outline of the insert portion 14. The base recessed area 20 includes a base recessed area surface 22. The depth of the base recessed area 20 is approximately equal to or slightly less than the thickness of the insert portion 14, but typically is approximately 0.150 inches deep, however, this specific depth is exemplary only, with the thickness of the insert portion 14 and the base portion 12 being a function of the strength of the material that the die is made of since the die must be rigid enough to withstand the forces created by a typical die press used in arts and crafts.

The base recessed area 20 includes a plurality of channels 24, and in the example shown in FIG. 1 includes channels 24a, 24b, 24c, and 24d. These channels are configured so as to provide a crease configuration upon the working medium after pressure is exerted to the working medium through the die and the die press.

The base portion 12 further includes a base portion extraction opening 26 which allows the user to insert a finger or the like from the base rear surface 16 and through the base portion extraction opening 26 so as to extract the working medium (not shown) from the base portion 12 after the working medium has been embossed or creased.

As shown in FIG. 1, the recessed area 20 has an outer configuration or shape 28 that is similar to, but slightly larger than the shape of the insert portion 14, which is defined by an outer shape or configuration 30 of the insert portion 14. It will be appreciated that the shapes shown of the insert portion and the base recessed area are exemplary only and that the shape of the insert portion 14 and the shape of the base recessed area 20 could be in any configuration with any configuration of channels 24.

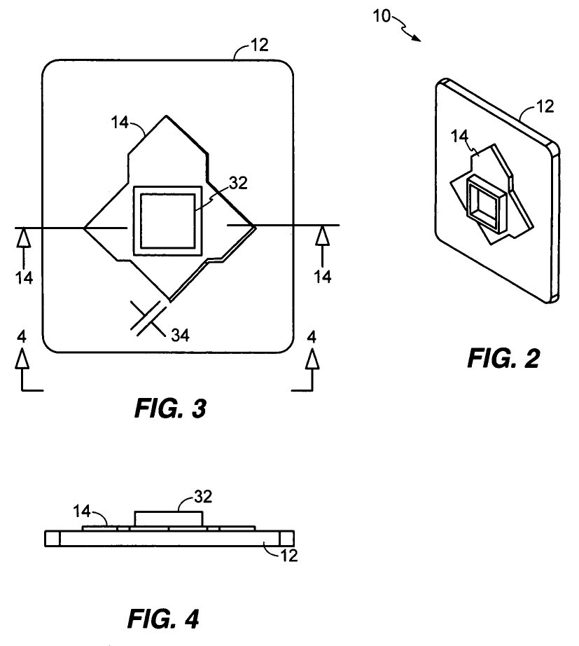

As shown in FIGS. 1-4, the insert portion 14 includes a handle 32, which allows the user to grip the insert portion 14 for inserting insert portion 14 into the base recessed area 20 and for extracting the insert portion 14 from the base recessed area 20. In addition, and as shown in FIG. 4, the handle 32 is generally parallel with the base portion 12 so that when the die 10 is inserted in between the lower and upper platens of a die press, one of the platens applies pressure to the handle 32 to force the insert portion 14 into the base recessed area 20 of the base portion 12. Since the handle 32 is generally parallel with the base portion 12, this also provides stabilization to the insert portion 14 as force is being applied to the insert portion 14 and to the die 10 in general.

As shown in FIG. 3, the insert portion 14 and, more particularly, the exterior surface or shape 30 of the insert portion 14 is slightly smaller than the base recessed area 20 and, more particularly, than the exterior surface or shape 28 of the base recessed area 20. This is defined by gap 34, which is typically in a range of 0.002 to 0.006 inches, and preferably 0.004 inches.

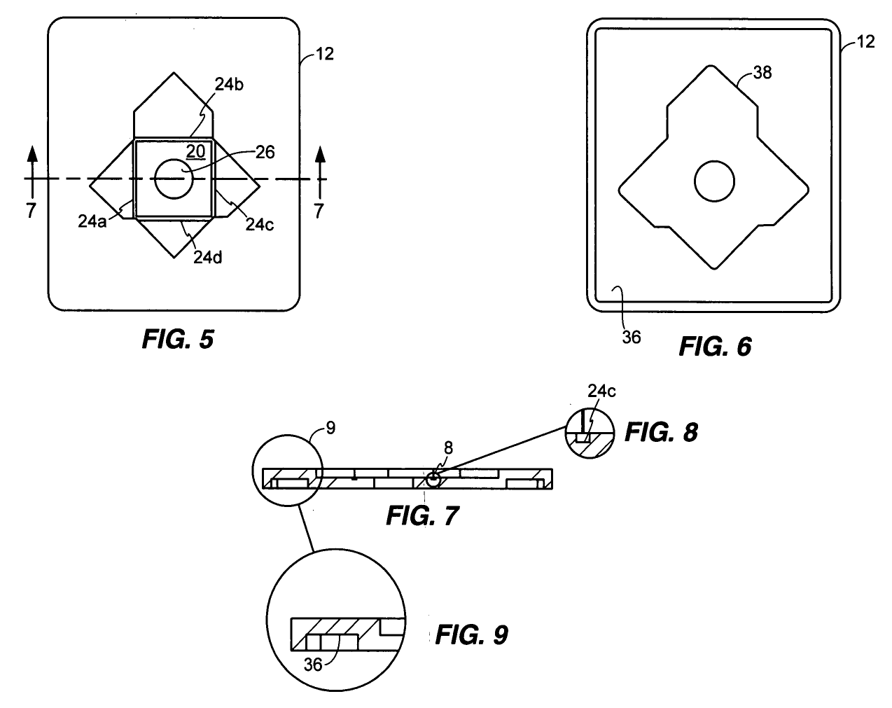

FIG. 6 illustrates that the rear area of the base portion 12 may include a relief 36 so that the die 10 may be easily made of an extruded plastic with the relief 36 providing an area where material is not needed, which enhances the ease of manufacturing the die 10 by a molding process. Shown also in FIG. 6 is a body 38 for the base recessed area 20. It will be appreciated that the features shown in FIG. 6 are exemplary only and not required for the die of the present disclosure.

FIGS. 7 through 9 illustrate further details about the channels 24 and relief 36 at the rear of the base portion 12.

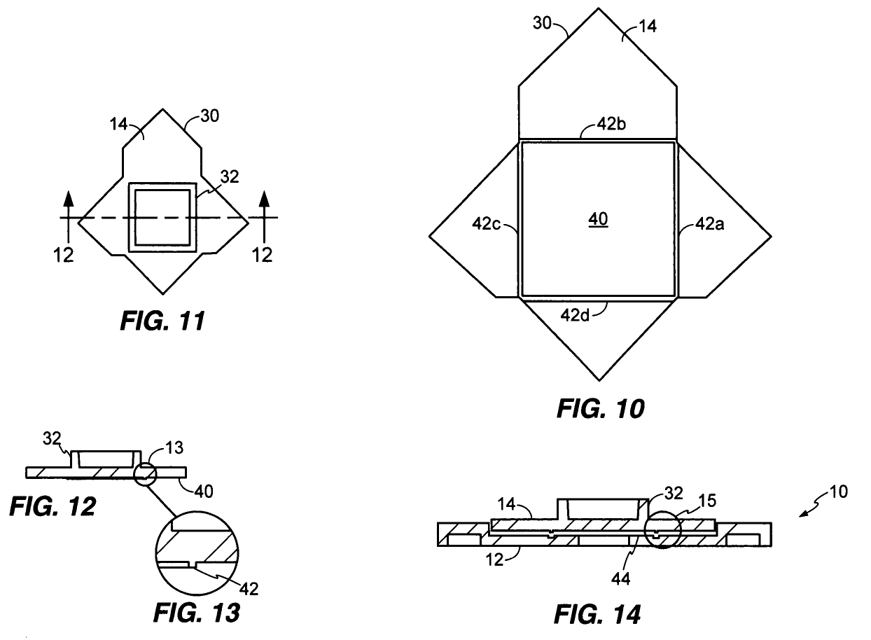

FIGS. 10 through 13 illustrate additional views of the insert portion 14. As shown in FIG. 10, the insert portion 14 includes a bottom surface 40. Bottom surface 40 is generally parallel to the base recessed area surface 22 when insert portion 14 is inserted into the base portion 12. FIGS. 10, 12, and 13 illustrate that the insert portion 14 includes a plurality of protrusions 42 that are adapted to communicate with, or be inserted into the corresponding channels 24 when the insert portion 14 is inserted into the recessed area 20 of the base portion 12. For example, when the insert portion 14 is inserted into the base portion 12 and, more particularly, into the recessed area 20, protrusion 42a communicates with or is inserted into channel 24a. Likewise, protrusion 42b is inserted into channel 24b, protrusion 42c is inserted into channel 24c, and protrusion 42d is inserted into channel 24d.

In the example shown, the insert portion and the corresponding base recessed area 20 are not symmetrical in shape and, therefore, the insert portion 14 may be inserted with only one orientation relative to the base recessed area 20. If, however, the configuration of the insert portion and the base recessed area are symmetrical in shape, such as a square or a circle, the insert portion would include a key with the base recessed area including a keyway so that the insert portion could only be inserted into the base recessed area with one orientation of the insert portion relative to the base portion.

FIG. 14 illustrates the die 10 shown with the insert portion 14 inserted into the base recessed area 20 of the base portion 12, with the insert portion 14 and the base portion 12 sandwiching a working medium 44.

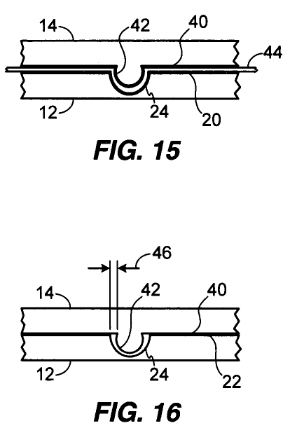

FIG. 15 illustrates a close-up view taken from FIG. 14 wherein the working medium 44 is shown sandwiched between the insert portion 14 and the base portion 12. FIG. 15 illustrates the working medium and the die portions after force has been exerted to the die. As shown, the working medium 44 has been worked, or embossed or creased by the die and, more particularly, by the protrusion 42 deforming the working medium 44 by pushing the working medium 44 into the channel 24. It should be noted that with the die of the present disclosure, the working medium 44 is embossed or creased, however, the working medium 44 is not crushed or deformed to the point of structural failure due to a controlled insertion of the protrusion 42 into the channel 24.

As shown in FIG. 16, this controlled working of the working media 44 is provided by controlling the depth of the insertion of the protrusion 42 into the channel 24. As shown in FIG. 16, without the working medium 44 for illustrative purposes only, when the insert portion 14 is placed into the recessed area 20 at the base portion 12, the protrusion 42 is inserted in a controlled fashion into the channel 24 since the insert bottom surface 40 is flush against, or bottomed out against, the base recessed area surface 22. This controlled depth of insertion of the protrusion 42 into the channel 24 defines a working area 46. The working area 46 is approximately the thickness of the working medium (not shown in FIG. 16). A typical thickness of a working medium may be in the range of 0.005 to 0.14 inches. Therefore, as provided by the die disclosed herein, the working medium 44 is not crushed or worked to the point of structural failure and, therefore, the resulting crease or embossing of the working material allows the resulting shape or configuration of the working medium to maintain structural integrity.

The operation of the die disclosed herein includes the user cutting a shape into a working medium by using a die press and a die, such as a steel rule die, a thin die, or the like. Once the shape is cut in the working medium the cutting die is removed from the die press and the resulting shape in the working medium is inserted into a corresponding crease die, as disclosed herein. Therefore, the user will match the resulting cut working medium with the crease die and place the cut working medium into the crease die base portion and then the user will place the insert portion into the base recessed area of the base portion. Next, the user places the crease die into the die press and exerts force to the working medium by operating the die press. Next, the user removes the crease die from the die press and lifts the insert portion from the base portion of the crease die. Next, the user, if necessary, will extract the working medium from the base portion by utilizing the base portion extraction opening.

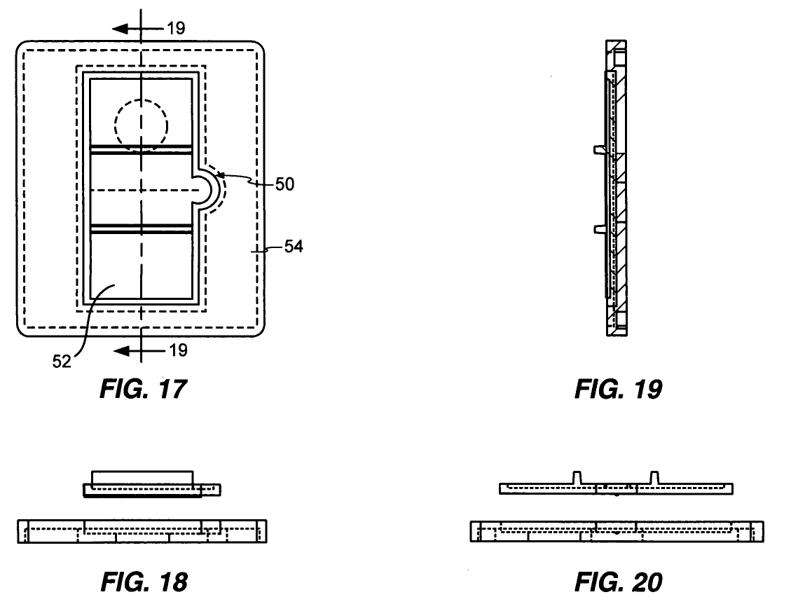

FIGS. 17 through 20 discloses a second embodiment of the crease die according to the present disclosure. The crease die according to the second embodiment is generally the same as the crease die disclosed above, however, the base portion and the insert portion include a key system 50, as shown on page 17, so that the insert portion 52 is inserted with the proper orientation relative to the base portion 54. FIGS. 18 through 20 illustrate additional views of the crease die according to the second embodiment.

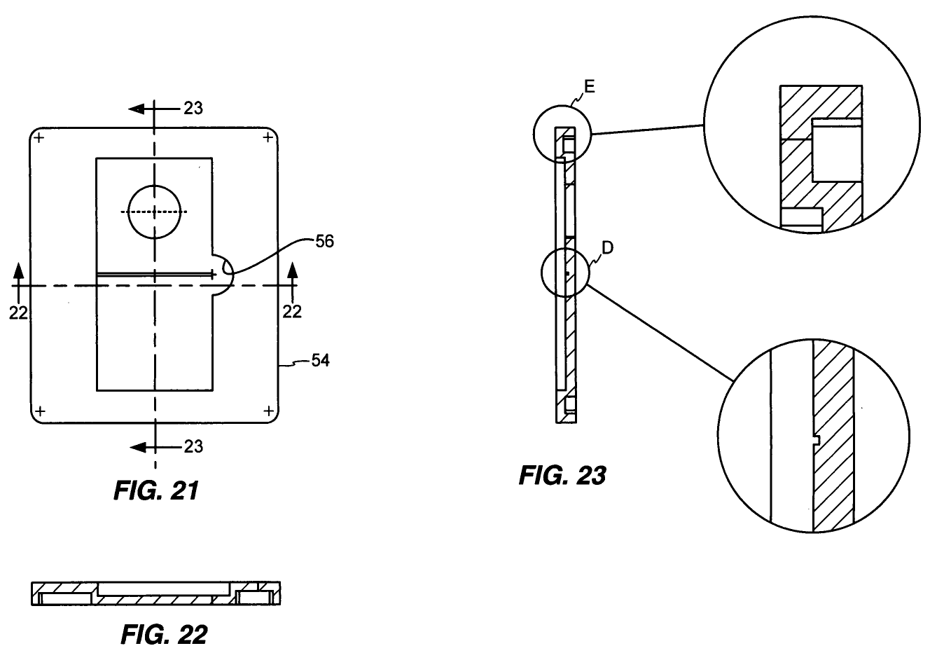

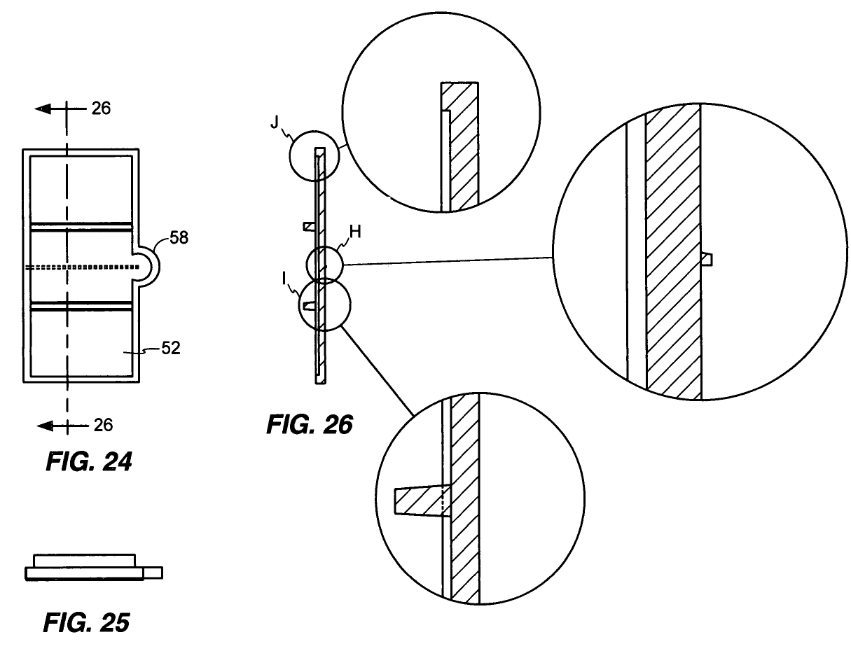

FIGS. 21 through 23 illustrate additional views of the base portion 54 of the second embodiment. The base portion 54 includes a keyway 56, which accepts the key 58 of the insert portion 52, shown in FIG. 24. FIGS. 24 through 26 illustrate the insert portion 52 of the second embodiment.

The crease die of the second embodiment utilizes a key and keyway so that the insert portion may be inserted into the base portion with the proper orientation. It will be appreciated by those skilled in the art that a non-symmetrical shape, such as that shown in the first embodiment in FIG. 1, will not require a key system 50 as shown in the second embodiment. Nevertheless, a symmetrical shape, such as the rectangular shape shown in the second embodiment, may utilize a key system 50, with a keyway 56 and a key 58 so that the insert portion 52 is inserted with the proper orientation into the base portion 54.

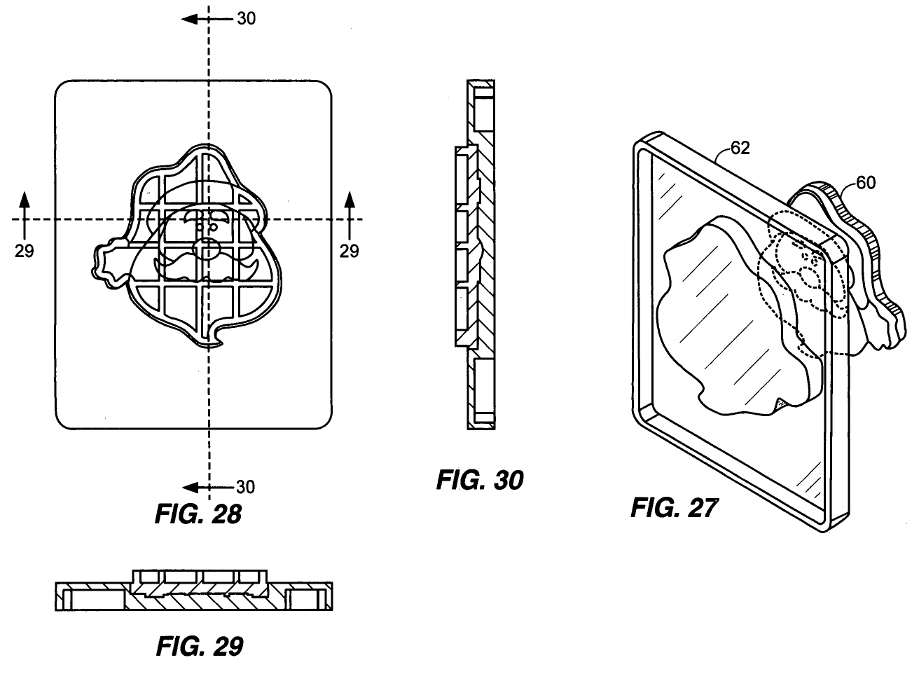

FIG. 27 illustrates a rear perspective view of a third embodiment of a crease die according to the present disclosure, wherein the insert portion 60 is seen through the base portion 62. In the third embodiment, the base portion and the insert portion are used to emboss an image onto a working medium. In this embodiment, the image is embossed in three dimensions. For example, the working medium after being embossed by a crease die of the third embodiment, would have varying depths of the Santa's face such as varying depths for the nose versus the mustache versus the beard versus the eyebrows versus the trim on the hat versus Santa's cheeks.

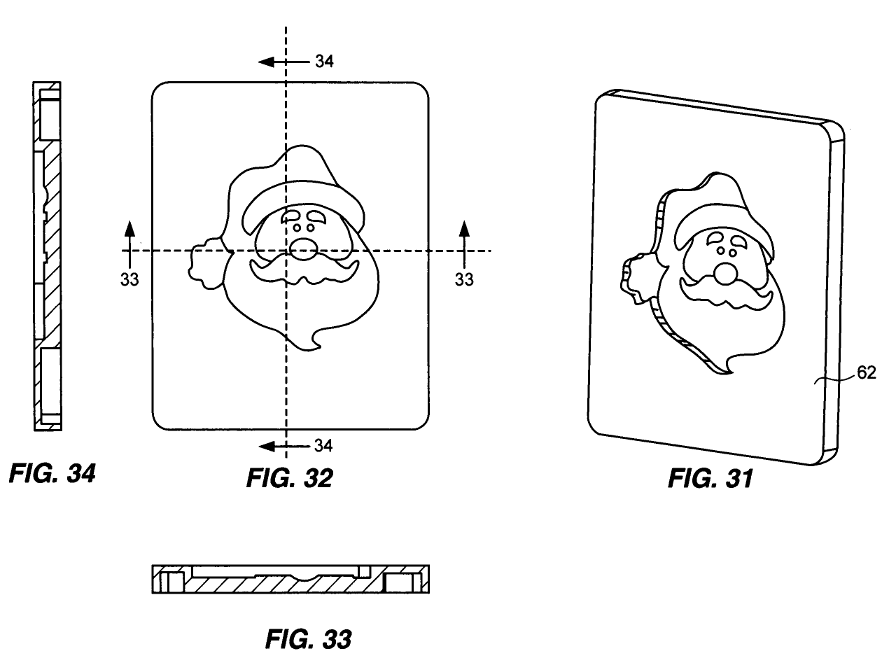

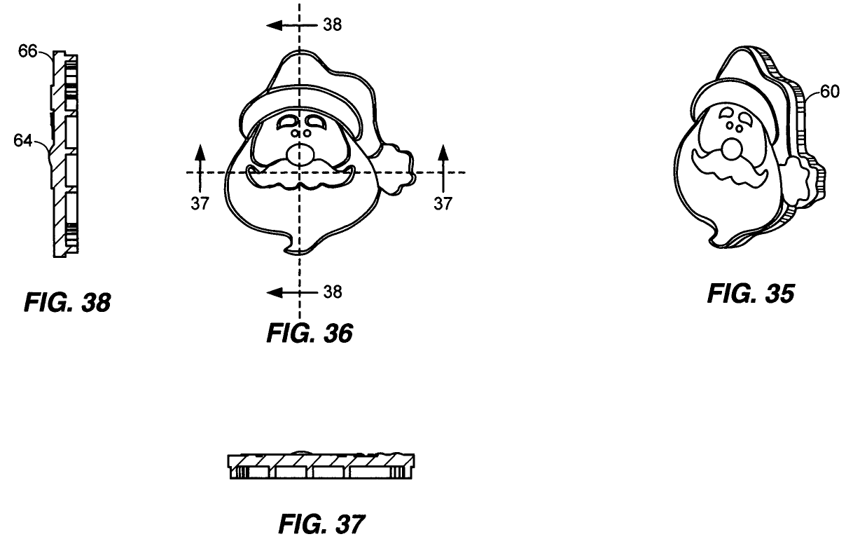

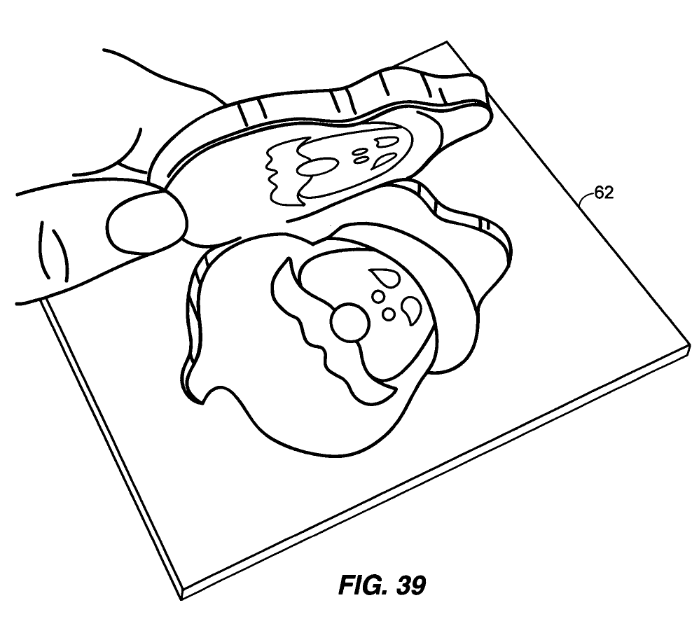

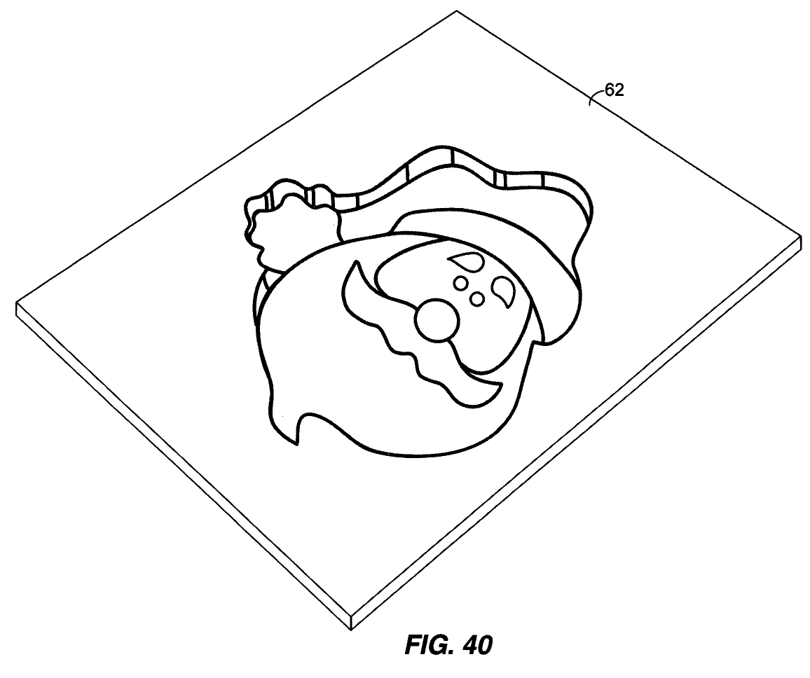

FIGS. 31 through 34 illustrate the base portion 62 of the third embodiment. FIGS. 35 through 38 illustrate the insert portion 60 of the third embodiment. In FIG. 38, which is a cross-sectional view taken from line F-F from FIG. 36, it is shown that the nose portion 64 of Santa's face is at a varying and different depth compared to the rest of Santa's face, such as the trim 66 of Santa's hat.

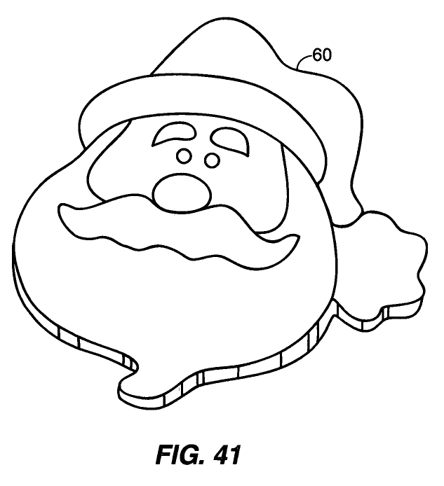

FIGS. 39 through 41 illustrate that, in this embodiment, that the base portion 62 includes what would generally be considered female portions or recesses that mate with the male portions or protrusions of the insert portion 60. Therefore, when a working medium is placed in between the base portion 62 and the insert portion 60, and when pressure is applied to the working medium, the working medium is formed to a three dimensional shape according to the configuration of the crease die. The crease die of the third embodiment may be made by a CNC machine or may be injection molded with the master die being made by a CNC machine.

It will be appreciated by those skilled in the art that the crease die according to the present disclosure may be used in a die press as explained above, however the crease die also may be used without a die press. For example, a working medium may be formed or embossed by a user even applying hand pressure to the crease die, or by using a hammer, or by any other means that applies pressure to the base portion or the insert portion relative to each other. A precision machine is not needed, and even an unbalanced load would suffice.

Although this disclosure has been shown and described with respect to detailed embodiments, those skilled in the art will understand that various changes in form and detail may be made without departing from the scope of the claimed disclosure.

1. A crease die, comprising:
a base portion having a recessed area;
the recessed area having a channel;
an insert portion having a body that is adapted to be inserted into the recessed area of the base, the insert further having a protrusion that is adapted to be inserted into the channel.

2. The crease die of claim 1, wherein when the insert portion is inserted into the base portion, a gap is defined between the insert portion and the base portion.

3. The crease die of claim 2, wherein the insert portion and the base portion further include a means of registration.

4. The crease die of claim 3, wherein the means of registration further includes:
a recessed area of the base further including a keyway; and
the insert further including a key adapted to mate with the keyway.

5. The crease die of claim 2, wherein the insert further includes a top surface with a grip extending outward from the insert top surface.

6. The crease die of claim 5, wherein the grip is generally parallel to the insert bottom surface to provide a stabilizer for when pressure is applied to the crease die.

7. The crease die of claim 2, wherein the base further includes an opening to allow a means for extraction from the base portion.

8. The crease die of claim 2, wherein the base portion and the insert portion are both made from a plastic material.

9. The crease die of claim 8, wherein the base portion and the insert portion are made from material with a durometer range of 85 a to 75 v.

10. A crease die, comprising:
a base portion having a top surface with a recessed area;
the recessed area having a plurality of channels defining a shape;
an insert portion having a body with a bottom surface that is adapted to be inserted into the recessed area of the base portion;
the insert portion further having a plurality of protrusions that are adapted to be inserted into the plurality of channels;
the top surface of the base portion being adapted to provide resistance to the bottom surface of the insert when the insert is inserted into the recessed area of the base portion to prevent the plurality of protrusions from contacting the plurality of channels.
